(19) United States
(12) Patent Application Publication
(10) Pub. No.: US 2017/0237350 A1
(43) Pub. Date: Aug. 17, 2017

(54) DC-DC CONVERTER

(71) Applicant: SII Semiconductor Corporation, Chiba-shi (JP)

(72) Inventors: Akihiro KAWANO, Chiba-shi (JP); Katsuya GOTO, Chiba-shi (JP)

(21) Appl. No.: 15/426,456

(22) Filed: Feb. 7, 2017

(30) Foreign Application Priority Data
Feb. 12, 2016 (JP) 2016-024860

(51) Int. Cl. H02M 3/158; H02M 1/32

(52) U.S. Cl. CPC H02M 3/158; H02M 1/32

(57) ABSTRACT

To provide a synchronous rectification type DC-DC converter equipped with a protection circuit operated stably. There is provided a DC-DC converter equipped with a detection circuit which detects that electrical energy accumulated in an inductor is lost, or a timer circuit which counts a prescribed time after the protection circuit detects an abnormality. When the protection circuit detects an abnormal state, an output control circuit brings a high-side switching element into an off state and brings a low-side switching element into an on state. After the electrical energy accumulated in the inductor is lost, the output control circuit turns off the low-side switching element according to an output signal of the detection circuit or the timer circuit.

### RELATED APPLICATIONS

This application claims priority under 35 U.S.C. §119 to Japanese Patent Application No. 2016-024860 filed on Feb. 12, 2016, the entire content of which is hereby incorporated by reference.

### BACKGROUND OF THE INVENTION

Field of the Invention

The present invention relates to a DC-DC converter which supplies electric power to an electronic device.

Background Art

A DC-DC converter is mounted with a protection circuit such as a power supply monitoring circuit, an output monitoring circuit, an overheat protection circuit, an overcurrent protection circuit, or the like, which stops a switching operation when an abnormal state is detected. Particularly in a synchronous rectification DC-DC converter, when an abnormal state is detected, a high-side switching element and a low-side switching element are both brought into an off state to stop the operation of the synchronous rectification DC-DC converter, thereby preventing the breakdown of the DC-DC converter.

One example of a schematic block diagram of a related art DC-DC converter is illustrated in FIG. 5. A protection circuit 31 is connected to an output control circuit 15. When the protection circuit 31 detects an abnormality and notifies the occurrence of the abnormality to the output control circuit 15, the output control circuit 15 transmits an off signal to both of a high-side driver 21 and a low-side driver 22 to simultaneously stop a PMOS transistor 2 and an NMOS transistor 4 (refer to, for example, Patent Document 1).

### Patent Document 1

### Japanese Patent Application Laid-Open No. 2004-080890

### SUMMARY OF THE INVENTION

In the related art DC-DC converter, when the PMOS transistor 2 and the NMOS transistor 4 are simultaneously stopped, electrical energy accumulated in an inductor 3 turns into a current flowing through a parasitic diode formed by a drain (N+) of the NMOS transistor 4 and a Psub substrate (P) and is discharged. When the current flows through the parasitic diode, the drain voltage of the NMOS transistor 4 becomes a negative voltage. Thus, the current flows through a parasitic NPN transistor formed by a drain (N+) of a switching element, the Psub substrate (P), and a drain (N+) of an N channel transistor of an internal circuit. Further, a problem arises that since the N channel transistor performs an unintended operation, the internal circuit will malfunction. For example, although the drivers are stopped, their stop operation is released due to the malfunction and hence a protection function cannot be operated normally.

The present invention has been invented to solve the above-described problems. The present invention is intended to realize a DC-DC converter equipped with a protection circuit operated stably.

In order to solve the related art problems, the DC-DC converter of the present invention is configured as follows:

The DC-DC converter is equipped with a detection circuit which detects that electrical energy accumulated in an inductor is lost. When a protection circuit detects an abnormal state, an output control circuit brings a high-side switching element into an off state and brings a low-side switching element into an on state. When the detection circuit detects that the electrical energy accumulated in the inductor is lost, the output control circuit turns off the low-side switching element.

The DC-DC converter is equipped with a timer circuit which counts a prescribed time after the protection circuit detects the abnormality. When the protection circuit detects an abnormal state, the output control circuit brings the high-side switching element into an off state and brings the low-side switching element into an on state. When the timer circuit counts the prescribed time, the output control circuit turns off the low-side switching element.

According to a synchronous rectification type DC-DC converter of the present invention, the DC-DC converter is equipped with a detection circuit which detects that electrical energy accumulated in an inductor is lost, or a timer circuit which counts a prescribed time after a protection circuit detects an abnormality. Further, a low-side switching element is turned off after electrical energy accumulated in an inductor is lost. Therefore, it is possible to prevent a malfunction of a protection function or the like in an internal circuit, thus making it possible to protect the switching element.

### BRIEF DESCRIPTION OF THE DRAWINGS

FIG. 1 is a schematic block diagram illustrating one example of a DC-DC converter according to a first embodiment;

FIG. 2 is a graph illustrating the operation of the DC-DC converter according to the first embodiment;

FIG. 3 is a schematic block diagram illustrating one example of a DC-DC converter according to a second embodiment;

FIG. 4 is a graph illustrating the operation of the DC-DC converter according to the second embodiment; and

FIG. 5 is a schematic block diagram of a related art DC-DC converter.

### DETAILED DESCRIPTION OF THE PREFERRED EMBODIMENTS

Preferred embodiments of the present invention will hereinafter be described based on the accompanying drawings.

### First Embodiment

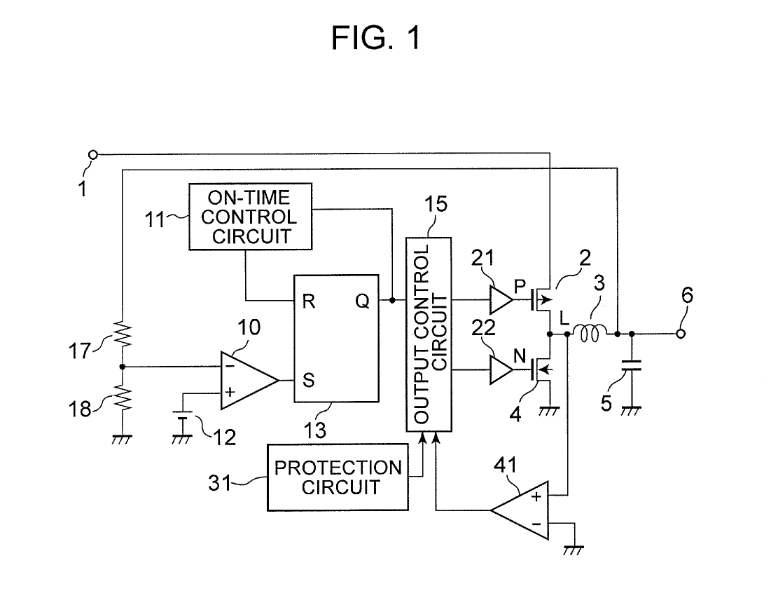

FIG. 1 is a schematic block diagram illustrating one example of a DC-DC converter according to a first embodiment.

The DC-DC converter according to the first embodiment is equipped with a PMOS transistor 2 which is a high-side switching element, an NMOS transistor 4 which is a low-side switching element, an inductor 3, a capacitor 5, a comparator 10, an on-time control circuit 11, a reference voltage circuit 12, an RS flip-flop 13, an output control circuit 15, a protection circuit 31, resistors 17 and 18 which are division resistors, a high-side driver 21, a low-side driver 22, a protection circuit 31, and a comparator 41. The protection circuit 31 may include, for example, a power supply monitoring circuit, an output monitoring circuit, an overheat protection circuit, an overcurrent protection circuit, etc.

The PMOS transistor 2 and the NMOS transistor 4 switch a dc current inputted from an input terminal 1. A voltage generated by the switching operation is smoothed by the inductor 3 and the capacitor 5 and outputted to an output terminal 6 as an output voltage Vout. The output voltage Vout is divided by the resistors 17 and 18 and inputted to the comparator 10. The comparator 10 compares the divided voltage and a reference voltage outputted from the reference voltage circuit 12 and outputs a comparison result therefrom. The R-S flip-flop 13 is configured to be inputted with the detected signal of the comparator 10 at an S terminal thereof, inputted with a signal of the on-time control circuit 11 at an R terminal thereof, and output a Q signal at a Q terminal thereof to the output control circuit 15. The output control circuit 15 outputs signals driving the PMOS transistor 2 and the switching element 4 through the driver 21 and the driver 22. The protection circuit 31 detects an abnormality in a circuit and outputs a detected signal to the output control circuit 15. The comparator 41 compares the voltage of a terminal (node L) on the input side of the inductor 3 with a GND voltage, detects that electrical energy accumulated in the inductor 3 is lost, and outputs a detected signal therefrom.

A protection operation of the DC-DC converter according to the first embodiment will next be described.

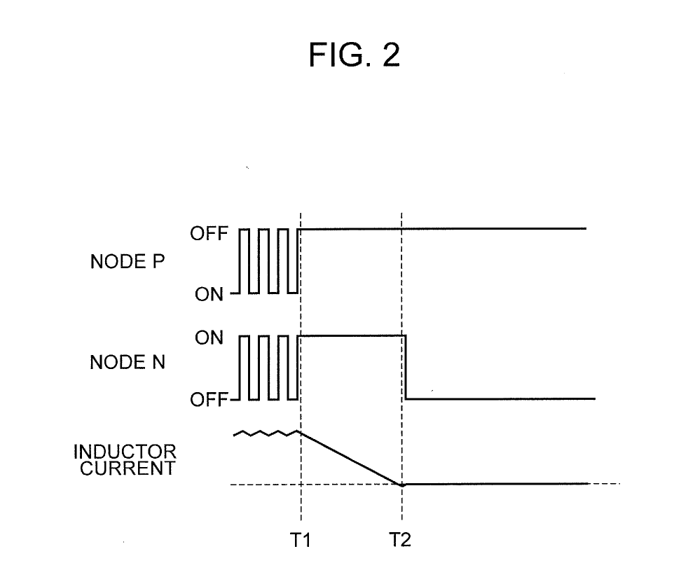

FIG. 2 is a graph illustrating the operation of the DC-DC converter according to the first embodiment.

A gate of the PMOS transistor 2 is assumed to be a node P, and a gate of the NMOS transistor 4 is assumed to be a node N.

When the protection circuit 31 detects an abnormal state such as an overcurrent flowing at T1, the protection circuit 31 outputs a detected signal to the output control circuit 15. When the output control circuit 15 receives the detected signal of the protection circuit 31, the output control circuit 15 outputs a signal of a high level to the driver 21 to turn off the PMOS transistor 2. Further, the output control circuit 15 outputs a signal of a high level to the driver 22 to turn on the NMOS transistor 4. The comparator 41 starts an operation in accordance with the detected signal of the protection circuit 31 and the signal turning on the NMOS transistor 4, for example.

Since the NMOS transistor 4 is turned on, the voltage of the node L is once brought to the GND voltage or less and gradually rises because the current flowing through the inductor 3 is gradually decreased. Further, when the current flowing through the inductor 3 is lost, i.e., the electrical energy accumulated in the inductor 3 is lost, the voltage of the node L becomes greater than or equal to the GND voltage (T2). Therefore, the comparator 41 outputs a detected signal to the output control circuit 15. When the output control circuit 15 receives the detected signal of the comparator 41 therein, the output control circuit 15 outputs a signal of a low level to the driver 22 to turn off the NMOS transistor 4.

By operating in this way, since a discharge current of the electrical energy accumulated in the inductor 3 does not flow through a parasitic diode formed by a drain (N+) of the NMOS transistor 4 and a Psub substrate (P), but flows through the source-to-drain of the NMOS transistor 4, a parasitic NPN transistor is not operated. Thus, it is possible to prevent a malfunction of a protection function or the like in an internal circuit and thereby protect each switching element.

### Second Embodiment

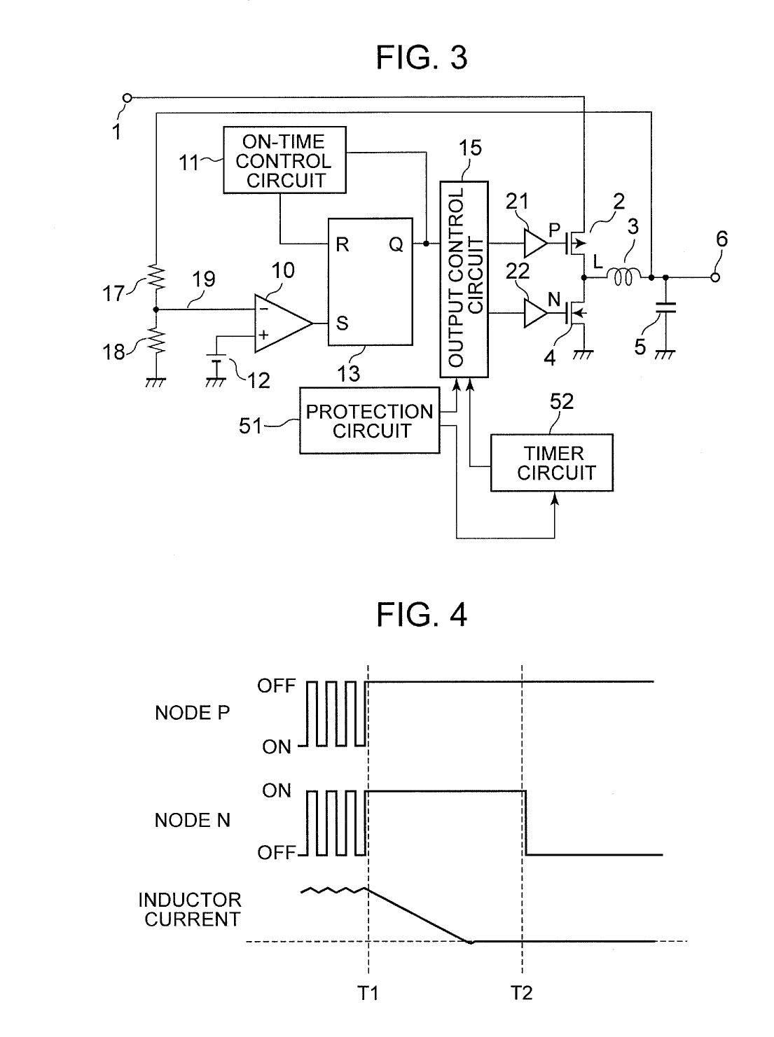

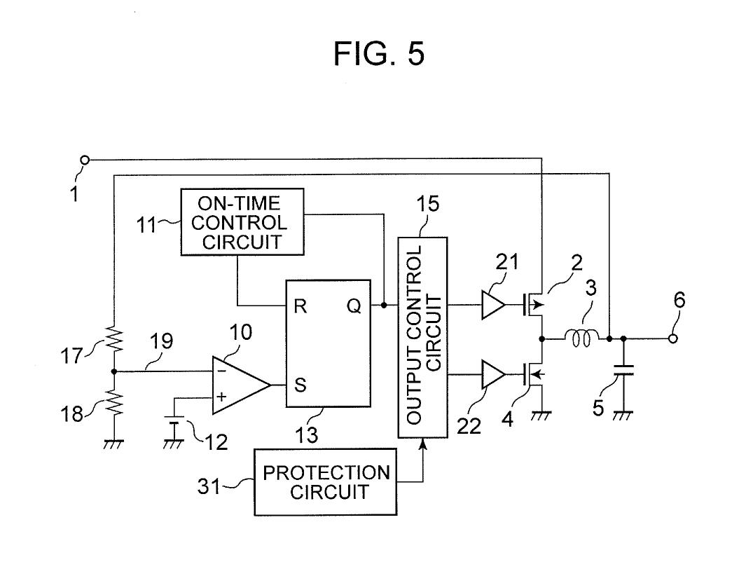

FIG. 3 is a schematic block diagram illustrating one example of a DC-DC converter according to a second embodiment.

The DC-DC converter according to the second embodiment is equipped with a protection circuit 51 and a timer circuit 52 instead of the protection circuit 31 and the comparator 41 in the circuit of the first embodiment.

The protection circuit 51 detects an abnormality in the circuit and outputs a detected signal to an output control circuit 15 and the timer circuit 52. The timer circuit 52 counts a prescribed time in response to the detected signal outputted from the protection circuit 51 and outputs a signal to the output control circuit 15 after the lapse of the prescribed time.

The operation of other circuits will be omitted because of being the same as in the first embodiment.

A protection operation of the DC-DC converter according to the second embodiment will next be described.

FIG. 4 is a graph illustrating the operation of the DC-DC converter according to the second embodiment.

When the protection circuit 51 detects an abnormal state such as an overcurrent flowing at T1, the protection circuit 51 outputs a detected signal to the output control circuit 15 and the timer circuit 52. When the output control circuit 15 receives the detected signal of the protection circuit 51 therein, the output control circuit 15 outputs a signal of a high level to a driver 21 to turn off a PMOS transistor 2. Further, the output control circuit 15 outputs a signal of a high level to a driver 22 to turn on an NMOS transistor 4. When the timer circuit 52 receives the detected signal of the protection circuit 51 therein, the timer circuit 52 starts counting and outputs a signal to the output control circuit 15 after the elapse of a prescribed time. When the output control circuit 15 receives the signal of the timer circuit 52 therein, the output control circuit 15 outputs a signal of a low level to the driver 22 to turn off the NMOS transistor 4.

The discharge time of electrical energy accumulated in an inductor 3 can simply be represented by the following equation:

Δt=L×IL/Vout

where Δt is the discharge time of electrical energy accumulated in the inductor, L is the inductance value of the inductor, IL is the inductor current value at the time of operation of the inductor, and Vout is the voltage of an output terminal 6.

By setting the set time of the timer circuit 52 to a time longer than the time taken for the electrical energy accumulated in the inductor 3 to be discharged, the NMOS transistor 4 can be turned off after a discharge current of the electrical energy accumulated in the inductor 3 becomes zero.

With the execution of the operation in this way, the discharge current of the electrical energy accumulated in the inductor 3 does not flow through a parasitic diode formed by a drain (N+) of the NMOS transistor 4 and a Psub substrate (P), but flows through the source-to-drain of the NMOS transistor 4. Therefore, a parasitic NPN transistor is not operated. Thus, it is possible to prevent a malfunction of a protection function or the like in an internal circuit and thereby protect each switching element.

What is claimed is:

1. A DC-DC converter comprising:
a PMOS transistor which is a high-side switching element;
an NMOS transistor which is a low-side switching element;
an inductor connected between a connecting point of the PMOS transistor and the NMOS transistor and an output terminal;
a protection circuit which outputs a signal in which an abnormality of the DC-DC converter is detected;
a detection circuit which outputs a detected signal when detects that the electrical energy accumulated in the inductor is lost; and
an output control circuit which turns off the PMOS transistor and turns on the NMOS transistor in response to the signal outputted from the protection circuit, and turns off the NMOS transistor in response to the detected signal outputted from the detection circuit.

2. The DC-DC converter according to claim 1, wherein the detection circuit is a comparator which compares a voltage of a terminal on the input side of the inductor with a GND voltage.

3. A DC-DC converter comprising:
a PMOS transistor which is a high-side switching element;
an NMOS transistor which is a low-side switching element;
an inductor connected between a connecting point of the PMOS transistor and the NMOS transistor and an output terminal;
a protection circuit which outputs a signal in which an abnormality of the DC-DC converter is detected;
a timer circuit which starts counting in response to the signal outputted from the protection circuit and outputs a signal when the timer circuit counts the prescribed time; and
an output control circuit which turns off the PMOS transistor and turns on the NMOS transistor in response to the signal outputted from the protection circuit, and turns off the NMOS transistor in response to the signal outputted from the timer circuit.

4. The DC-DC converter according to claim 3, wherein the prescribed time is longer than a time when the electrical energy accumulated in the inductor is discharged.
